(19) United States
(12) Patent Application Publication
(10) Pub. No.: US 2021/0244609 A1
(43) Pub. Date: Aug. 12, 2021

(54) Y-Shaped Percussion Massager with Side-Mounted Motor

(71) Applicant: Pado, Inc., Valencia, CA (US)

(72) Inventors: Steven Lee, Valencia, CA (US); Alejandro Garfio, Mission Viejo, CA (US)

(73) Assignee: Pado, Inc., Valencia, CA (US)

(21) Appl. No.: 17/182,040

(22) Filed: Feb. 22, 2021

Related U.S. Application Data
(63) Continuation-in-part of application No. 16/168,100, filed on Oct. 23, 2018, now Pat. No. 10,959,908.
Application No. 16/168,100 is a continuation-in-part of application No. 29/663,757, filed on Sep. 18, 2018, now Pat. No. D847364.
(60) Provisional application No. 62/980,221, filed on Feb. 22, 2020.

(51) Int. Cl. A61H 23/00; A61H 23/02; A61H 15/00

(52) U.S. Cl. CPC A61H 23/006; A61H 23/0254; A61H 2201/0153; A61H 2201/1436; A61H 15/0085

(57) ABSTRACT

A percussive massage appliance has a general Y-shape, with first and second handle portions being suitable for being held by first and second hands, respectively, of a user, with the percussive massage head reciprocating along an axis that lies in a major arc defined by the two handle portions. The device has a rotation mechanism such that the user can rotate the reciprocation axis through an arc of about 120 degrees relative to the handles. The massager has a side-mounted brushless motor that drives the reciprocating output shaft through a crank wheel, a crank pin, and a connecting rod, without any gears therebetween. Batteries can be located in each of the two handles, providing a large battery capacity.

### CROSS-REFERENCE TO RELATED APPLICATIONS

This application is a non-provisional of and claims priority to U.S. Provisional Patent Application No. 62/980,221, filed on Feb. 22, 2020, the entire contents of which are incorporated herein by reference. This application is also a continuation-in-part of and claims priority to U.S. patent application Ser. No. 16/168,100, filed on Oct. 23, 2018, which is a continuation-in-part of and claims priority to U.S. Design Patent Application Ser. No. 29/663,757, filed on Sep. 18, 2018, the entire contents of which are incorporated herein by reference.

### BACKGROUND OF THE INVENTION

### 1. Field of the Invention

This invention relates to the field of electric massage appliances. More particularly, this invention relates to the field of a versatile and ergonomic percussion massage appliance.

### 2. Description of Related Art

Electric massage appliances, which will be henceforth referred to simply as “massagers” for ease of discussion, provide both pleasure as well as relief from aching muscles after vigorous sporting activities such as competitive sports or strenuous workouts. The benefits of massage therapy for reducing Delayed Onset Muscle Soreness (DOMS) has been extensively documented in the medical literature since the early 1900's. Massagers can be of the vibration variety, percussion variety, and others. Numerous vibration massagers and percussion massagers in a wide variety of configurations have been designed and sold.

Percussion massagers work by driving a massage head in reciprocating linear motion so that it repeatedly impacts against the muscle or other tissue being massaged. U.S. Patent Publication 2013/0261516 by Cilea for example discloses a battery-operated percussive massager having variable frequency and variable power, and interchangeable massage heads. Cilea's device looks much like a jigsaw such as is typically used in construction work, but modified slightly to provide a percussive massage head at the end of a reciprocating shaft instead of a saw blade.

One design goal for massagers is that the device be ergonomic, i.e., easy to use by either a solo user or by a therapist using the device on a subject patient, without requiring the user or therapist to twist his body or limbs into uncomfortable positions in order to receive the desired massage at the user's desired target location, or to otherwise hold the device in a way that becomes uncomfortable or fatiguing after too short a period. Another design goal, particularly for percussive massagers, is that the device be easily usable to press against any one of numerous potential target locations on a user's body with a large variation in pressures ranging from slight pressure to very heavy pressure as the user desires, again without undue stress or fatigue on the person applying the device.

### SUMMARY OF THE INVENTION

The present invention is of a percussive electric massage appliance, or simply “massager,” that is both ergonomic and versatile. The device allows for a wide range of uses on various target locations on the human body with various application pressures, such that the device can effectively reach locations on the body that otherwise could not be effectively reached with prior massagers, especially for a solo user applying the device to his own body. The device also allows for less fatigue while using the device, whether the user is a solo user or a therapist, as compared to various prior massagers.

According to a first illustrative embodiment, a percussive electric massage appliance has a body that includes first and second handle portions extending from a central portion along first and second axes, respectively. The first and second handle portions define an obtuse angle between them, i.e., an angle of more than 90 degrees but less than 180 degrees, and preferably about 120 degrees. A reciprocating output shaft has a percussive massage head such as a ball attached to it for delivering the percussive massage to the subject. The reciprocating output shaft nominally subtends the major arc defined by the two handle portions, thus defining a generally Y-shaped device with the handle portions forming the arms of the “Y” and the output shaft forming the base of the “Y.” The reciprocating motion of the output shaft defines a reciprocation axis. A rotation mechanism or “hinge” in its broad sense allows the rotation axis to be rotated about a wide angle, preferably through an angle of approximately 120 degrees, relative to the two handle portions. A rotation lock allows the device to be locked at the desired angle. One or more of the handle portions releasably mates with a handle extension, such that the extension can be added to the device or removed from the device with ease.

By allowing the angle of the output shaft to be rotated through a large angle of approximately 120 degrees, and with a removable extension handle, a user can easily and without undue contortion apply the device to many areas on his body including his back and thus give himself a percussive massage. When the user is using the device on his own lower back, the two handle portions are aligned at natural angles for the user to hold his two hands behind his back, grip the two handle portions with his two hands, and pull the massage head against his own back to deliver a soothing percussive massage to his own lower back muscles.

By allowing great versatility of application without undue contortion or strain, the device defines a highly ergonomic and versatile percussive massager. The device also provides a versatile and ergonomic device that can be used by a massage therapist to give a percussive massage to the subject.

In one aspect therefore, the invention is of a percussive electric massage appliance having a body, the body having a central portion and first and second handle portions that are each suitable for a human to grip using the operator's first and second hands, respectively. The handle portions extend from the central portion such that they form a minor angle of between 75° and 180°, and preferably about 120°, between them. An electric drive motor assembly is located at least partially in the body. The electric drive motor assembly includes an electric drive motor that produces a rotational output, and gearing that translates the rotational output of the motor to reciprocating output at an output shaft located within the major arc between the handle portions, and with a massage head such as a massage ball being mounted at the end of the output shaft. Preferably the massage head can be easily changed. The device may come with a number of different massage heads. The two handle portions may be of slightly different sizes as measured at their respective circumferences to allow users having different sized hands to primarily use the handle portion that best matches their hand sizes.

A rotation mechanism or hinge allows the output shaft to rotate relative to the body including the two handle portions, such that the output shaft can be rotated to any desired angle relative to the handle portions, including in-line with the first handle portion, in-line with the second handle portion, midway between the handle portions, or positions therebetween. The rotation mechanism allows the output shaft to be rotated through an angle of more than 90° and preferably 120° or even more. A locking mechanism locks the output shaft in the desired rotational position.

In the first illustrative embodiment the motor is located within one handle portion and the battery, which may be rechargeable, is located in the other handle portion, so that the massager is evenly weight balanced.

In a second illustrative embodiment the motor is centrally located between the two handle portions and is side-mounted, and is preferably a brushless motor. In this embodiment a crank pin is affixed to the rotating motor shaft, and a connecting rod directly connects the crank pin to the reciprocating massager output shaft. This design eliminates the gearing between the rotating motor shaft and the reciprocating massager output shaft, thus eliminating the noise and efficiency loss associated with that gearing. This design is therefore quieter and more efficient.

Exemplary embodiments of the invention will be further described below with reference to the drawings, in which like numbers refer to like parts. The drawing figures might not be to scale, and certain components may be shown in generalized or schematic form and identified by commercial designations in the interest of clarity and conciseness.

### BRIEF DESCRIPTION OF THE DRAWINGS

FIG. 1 is a perspective view of a percussive electric massage appliance according to a first exemplary embodiment of the present invention, with the extension handle attached.

FIG. 2 is a cutaway closeup view of the massager of FIG. 1, in the area where the extension handle mates with one of the handle portions.

FIG. 3 is an exploded view of the massager of FIG. 1 including both the extension handle and an end cap for when the extension handle is not present.

FIG. 4 is a front elevation view of the massager of FIG. 1 with the end cap installed in place of the extension handle.

FIG. 5 is a cutaway view of the massager of FIG. 4.

FIG. 6 is a partial perspective view showing an internal gearing and a rotation mechanism of the massager of FIG. 1, and showing the massager output shaft at its distal-most extension.

FIG. 7 is the same view as FIG. 6 but showing the massager output shaft at its proximal-most position.

FIG. 8 is a front elevation view of the massager of FIG. 4, and showing in ghost lines different positions into which the output shaft can be rotated and locked.

FIG. 9 is a front elevation view of the massager of FIG. 4, showing the massager output shaft rotated so that it is in line with the longitudinal axis A1 of the first handle section.

FIG. 10 is a front elevation view of the massager of FIG. 4, showing the massager output shaft rotated so that it is in line with the longitudinal axis A2 of the second handle section.

FIG. 11 is a front elevation view of the massager of FIG. 4.

FIG. 11A is a cross-sectional view of the massager of FIG. 11 taken along section line A-A.

FIG. 11B is a cross-sectional view of the massager of FIG. 11 taken along section line B-B.

FIG. 11C shows the two cross-sections shown in FIGS. 11A and 11B superimposed.

FIG. 12 is partially exploded view of the massager of FIG. 4, showing the rotation locking mechanism in exploded form.

FIG. 13 is a sectional view of the massager of FIG. 12 but non-exploded, showing the rotation locking mechanism in its locked position.

FIG. 14 is a sectional view of the massager of FIG. 12 but non-exploded, showing the rotation locking mechanism in its unlocked position.

FIG. 15 is a rear view of a user using the massager of FIG. 1 according to a first possible use thereof.

FIG. 16 is a rear view of a user using the massager of FIG. 1 according to a second possible use.

FIG. 17 is a perspective view of a therapist using the massager of FIG. 1 on a patient according to a third possible use.

FIG. 18 is a perspective view of a user using the massager of FIG. 1 according to a fourth possible use.

FIG. 19 is a perspective view of a user using the massager of FIG. 1 according to a fifth possible use.

FIG. 20 is a perspective view of a user using the massager of FIG. 1 according to a sixth possible use.

FIGS. 21-23 are side are partially cut-away views of a percussive electric massage appliance according to a second exemplary embodiment, having a centrally located side-mounted motor.

FIGS. 24-26 are side, front, and bottom views, respectively, of a percussive electric massage appliance of FIG. 21.

FIG. 27 is a conceptual diagram illustrating the space available for batteries in the second illustrative embodiment of FIG. 21.

### DETAILED DESCRIPTION OF THE PREFERRED EMBODIMENTS

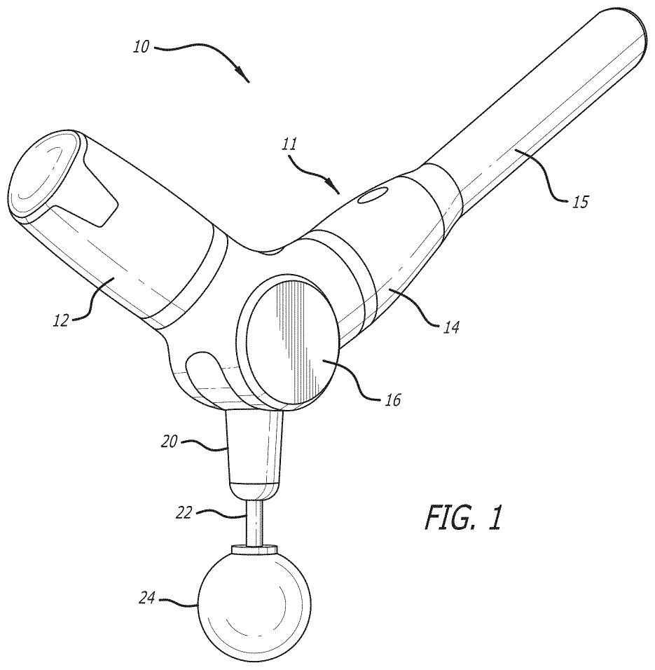

FIG. 1 is a perspective view of a percussive electric massage appliance or simply “massager” 10 according to an exemplary embodiment, with an extension handle 15 attached. Massager 10 includes a body 11 having a first handle portion 12 adapted and suitable for being gripped by a first hand of a user, a second handle portion 14 adapted and suitable for being gripped by a second hand of the user, and a central portion 16. Extension handle 15 releasably attaches to second handle portion 14. At the output end of massager 10 a massage head 24 such as the massage ball shown is affixed to the distal end of a reciprocating output shaft 22. Output shaft 22 is guided within guide tube 20.

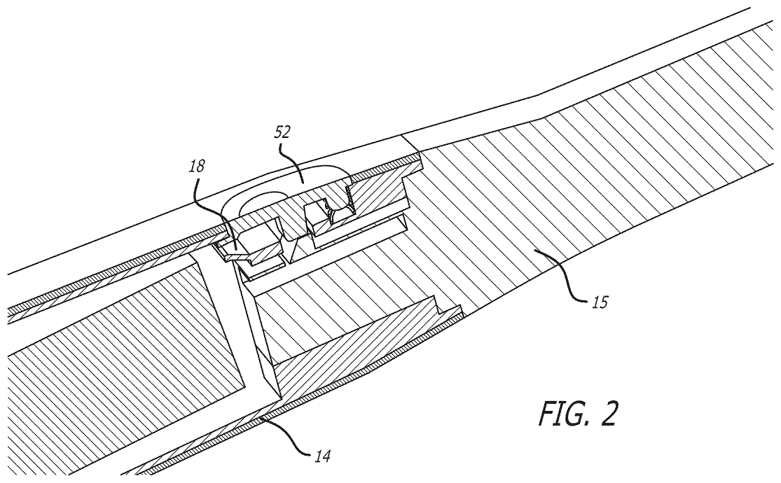

FIG. 2 is a cutaway closeup view of the massager 10 of FIG. 1, in the area where the extension handle 15 mates with second handle portion 14. In this embodiment biased locking tab 18 on extension handle 15 engages second handle portion 14. When a user presses down on release button 52, locking tab 18 disengages from second handle portion 14 and the extension handle can be removed. Other mechanisms for releasably mating two pieces together are well known and could be substituted.

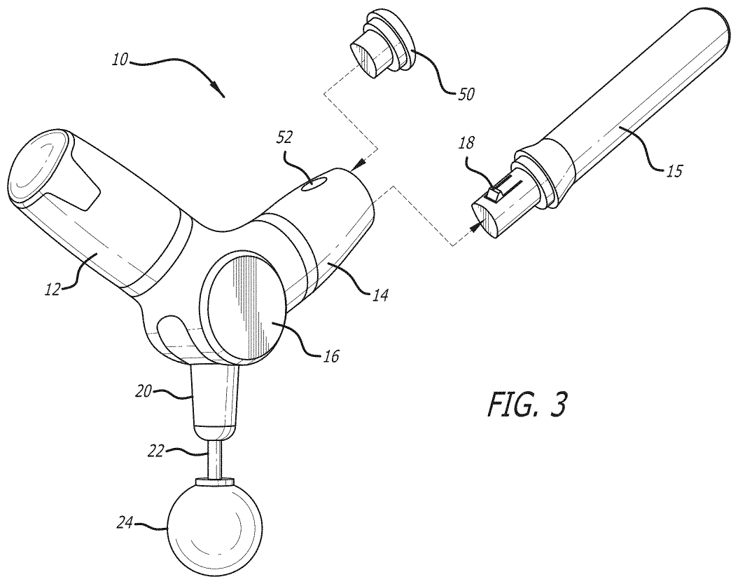

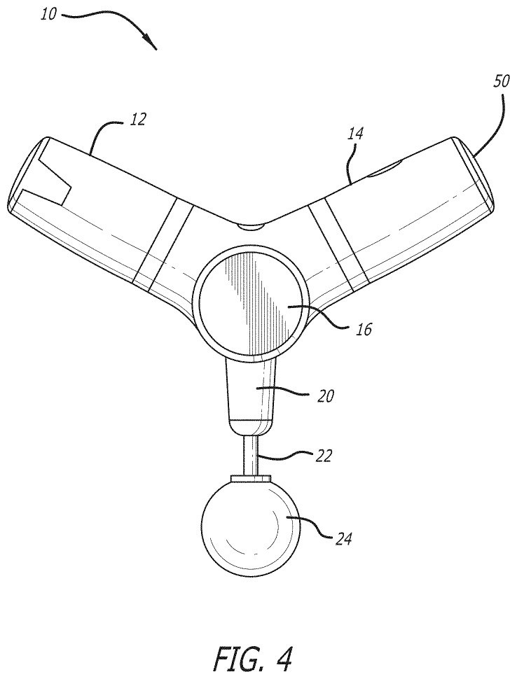

FIG. 3 is an exploded view of the massager 10 of FIG. 1 including both the extension handle 15 and an end cap or cover 50 for when the extension handle is not being used. The releasable extension handle allows a user to quickly change the massager between the configuration shown in FIG. 1 with the extension handle, to the configuration shown in FIG. 4 without the extension handle. As will be shown and described in greater detail later, the extension handle allows the user to effectively apply the massager to places on his body otherwise not possible for a solo user, and to reach other places more easily and ergonomically.

FIG. 4 is a front elevation view of the massager 10 of FIG. 1 with end cap 50 installed in place of extension handle 15. End cap 50 maintains a clean and aesthetic appearance of the massager with smoothly curved edges when extension handle 15 is not present.

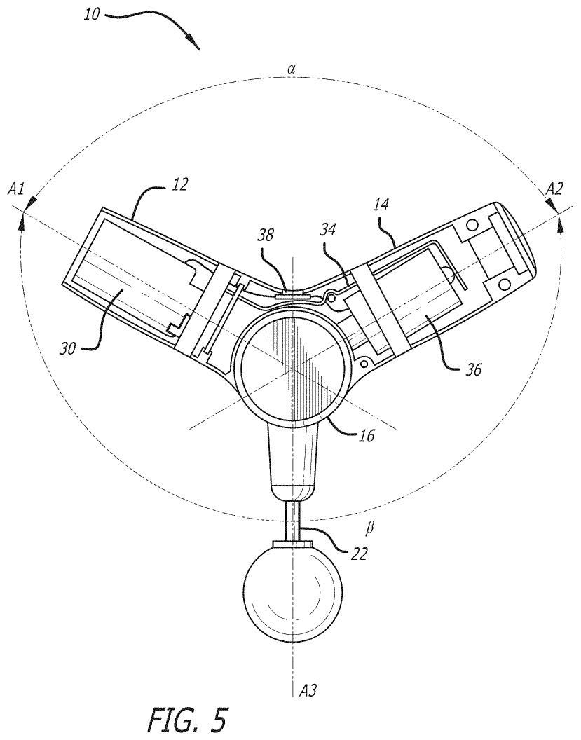

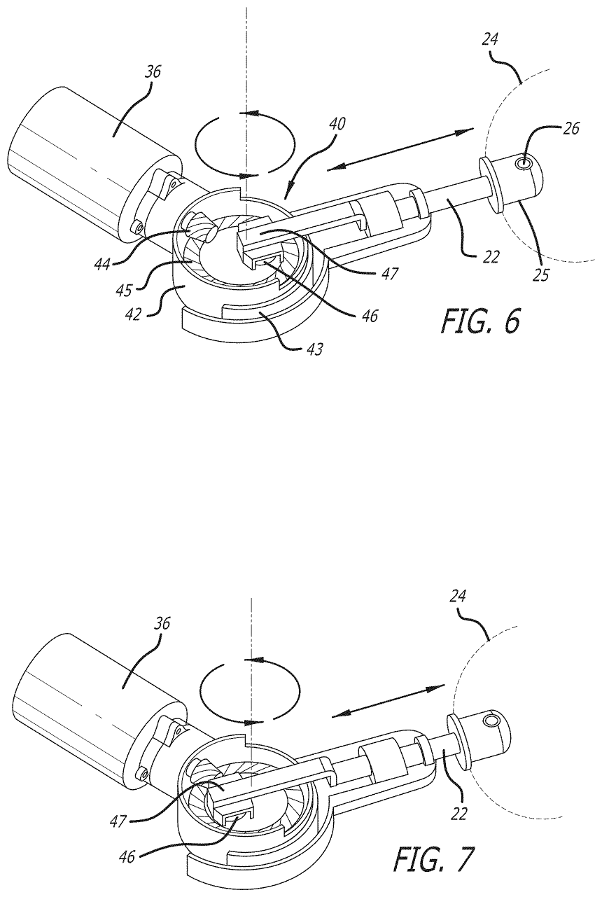

FIG. 5 is a cutaway view of the massager of FIG. 4. In this figure the following parts can be seen: battery 30; an associated electrical ON/OFF switch 38; electrical wire(s) 34; and an electric drive motor 36. Battery 30 is disposed within first handle portion 12, and electric drive motor 36 is disposed within second handle portion 14. In this context, “disposed within” means disposed at least partially within. Battery 30 is preferably a rechargeable battery that is chargeable through either a wired charging port (not shown) or a wireless charging system. Alternatively, battery 30 could be a non-rechargeable, replaceable battery. With battery 30 in the first handle portion 12 and motor 36 in second handle portion 14, and the gearing in the central portion 16 (FIG. 6), massager 10 is evenly balanced in weight between its left and right sides. “Evenly balanced” can mean that the weights of the two handle portions and hence the two sides are within 5% of each other, or within 10% of even other, or within 20% of each other.

First handle portion 12 has a longitudinal axis A1. Likewise, second handle portion 14 has a longitudinal axis A2. Reciprocating output shaft 22 which extends from the central portion 16 of body 11 has an associated axis of reciprocation A3. Output shaft 22 is operatively coupled to the electric drive motor to produce linear reciprocating motion at output shaft 22 and at percussive massage head 24 affixed to the distal end of output shaft 22.

The first and second handle portions 12, 14 and their associated longitudinal axes A1, A2 define an obtuse angle that defines minor arc a between them, and also define a major arc R. Minor arc a defines an angle of less than 180° and preferably less than 160°, but more than 75°, and preferably more than 90°, more than 100°, more than 110°, less than 130°, and more preferably still the minor arc a between the first and second handle portions defines an angle of approximately 120°. In the nominal position for massager 10 shown in the figure, the massager has a Y-shape, with reciprocating axis A3 being within and bifurcating major arc (3, and defining an angle of 120° with each of first axis A1 and second axis A2.

FIG. 6 is a partial perspective view showing an internal gearing mechanism and a rotation mechanism 40 of the massager of FIG. 1, and showing the massager output shaft 22 at its distal-most extension. Rotation mechanism 40, which constitutes a type of hinge, allows output shaft 22 to rotate or pivot relative to body 11 of the massager 10 including relative to first and second handle portions 12, 14.

Rotation mechanical 40 includes a generally circular inner housing or hub 42 rotating within a generally circular outer housing or hub 43. Inner housing 42 is rotationally fixed to the handle portions 12, 14. The output shaft 22 is rotationally fixed to outer housing 43, such that as the inner and outer housings rotate relative to one another, output shaft 22 rotates or pivots relative to the handle portions 12, 14. The result is that the output shaft 22 can rotate to a user-selected angle relative to the first and second handle portions 12, 14.

A gearing mechanism housed within inner housing 42 translates rotational output from motor 36 to reciprocating output at reciprocating output shaft 22, so as to operatively couple electric drive motor 36 to produce linear reciprocating motion at output shaft 22 including at a distal end thereof. The gearing includes a first spiral bevel gear 44 which is directly coupled to the output of motor 36, and a second spiral bevel gear 45 which meshes with first spiral bevel gear 44. As bevel gears 44 and 45 rotate, crank pin 46 moves in a circular path as shown. Connecting rod 47 is connected to crank pin 46 such that as crank pin 46 moves in a circular path, connecting rod 47 moves in both circular and reciprocating motion, and output shaft 22 which is driven by connecting rod 47 moves in a linear reciprocating motion. This type of gearing and mechanism for translating circular motion to reciprocating motion is, by itself, well known. Additional details of the mechanism that are not shown or described herein will be apparent to those of skill in the mechanical engineering arts.

Also seen in the figure is a shaft head 25 on output shaft 22 having a spring-biased button 26. These features allow a variety of different massage heads such as massage ball 24 to be easily installed on massager 10 and removed for quick and easy interchangeability of massage heads, in much the same way that sockets are quickly and easily changed on a socket wrench. Other mechanisms including other quick-change mechanisms are possible to allow the massage heads to be easily changed.

FIG. 7 is the same view as FIG. 6 but showing the massager output shaft 22 at its proximal-most position. As second spiral bevel gear 45 rotates, output shaft 22 and percussive massage head 24 reciprocate, delivering a percussive massage to the user.

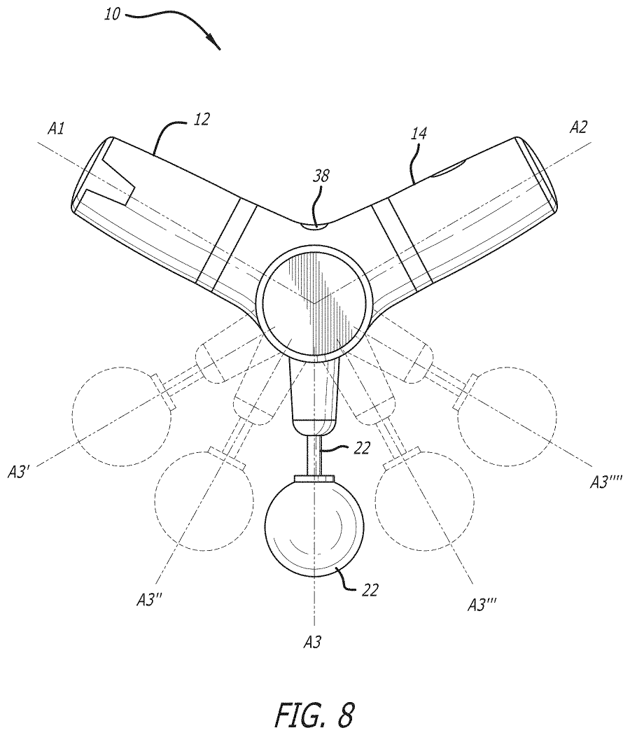

FIG. 8 is a front elevation view of the massager of FIG. 4, and showing in ghost lines different positions into which output shaft 22 and associated massage head 24 can be rotated and locked. Five positions are shown, showing reciprocating axis A3 at five different orientations, namely, A3, A3′, A3″, A3″, and A3′″. The mechanism can be continuously pivoted through that range of angles, and in the illustrative embodiment can be locked into any of the five positions shown.

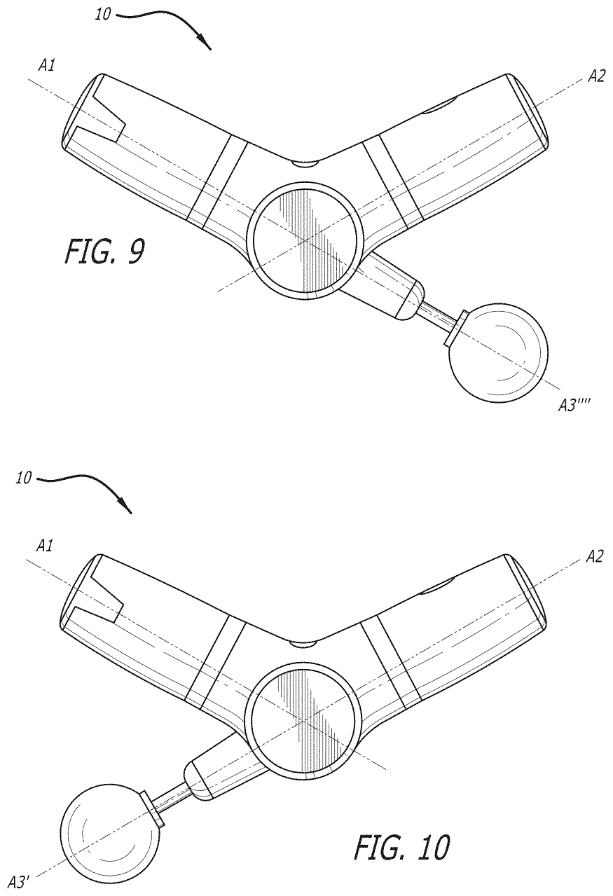

FIG. 9 is a front elevation view of the massager 10 of FIG. 4, showing the massager output shaft 22 rotated so that reciprocating axis A3 is in line with the longitudinal axis A1 of the first handle section. More generally, A1 and A3 are parallel and may be, but need not be, in line. Output shaft 22 can be locked into this position.

FIG. 10 is a front elevation view of the massager 10 of FIG. 4, showing the massager output shaft 22 rotated so that it is in line with the longitudinal axis A2 of the second handle section. More generally, A1 and A2 are parallel but need not be exactly in line. Output shaft 22 can be locked into this position. Output shaft 22 and associated reciprocating axis A3 can thus be rotated through an angle of more than 90°, and preferably more than 100° and 110°, and in this embodiment through a full 120° to be parallel with either handle portion 12, 14 and their associated axes A1, A2. When the extension handle 15 (FIG. 1) is attached, therefore, reciprocating axis A3 can either form an acute angle of approximately 60° with extension handle 15 as it would in FIG. 9 if the extension handle were attached, or can be parallel and in line with extension handle 15 as it would be in FIG. 10.

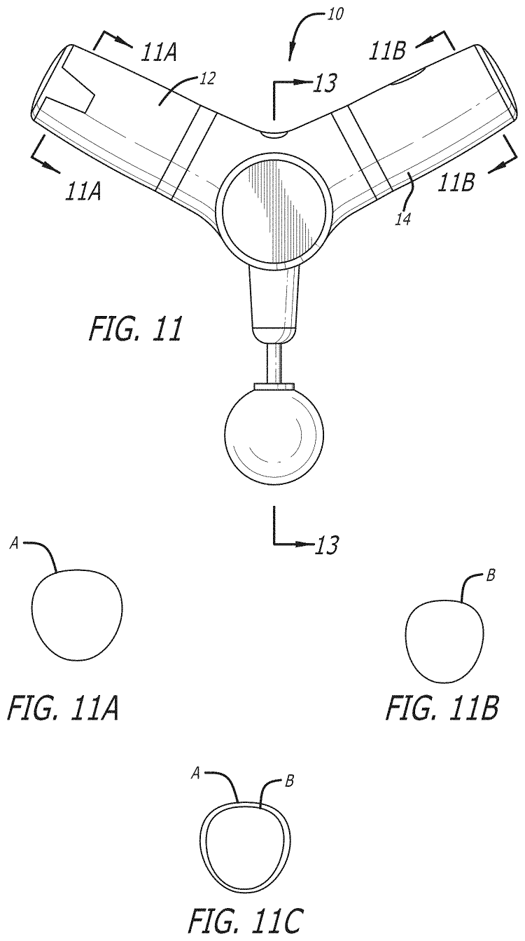

FIG. 11 is a front elevation view of the massager 10 of FIG. 4. FIG. 11A is a cross-sectional view of the massager of FIG. 11 taken along section line A-A, and FIG. 11B is a cross-sectional view of the massager of FIG. 11 taken along section line B-B taken at a corresponding position on the handle portion, i.e., taken at the same distance from a midpoint of the device, and taken the same distance from the respective distal ends of the handle portions 12, 14. FIG. 11C is a cross-sectional view of the massager of FIG. 11 showing the cross-sections taken along taken along section lines A-A and B-B superimposed. As can be seen in these figures, the cross-section A of first handle portion 12 has a greater circumference than does cross-section B of second handle portion 14. This difference in handle sizes allow users having different sized hands to primarily use the handle portion that best matches their hand sizes. The difference in circumferences can be greater than 10%, and greater than 20%, in order to ergonomically accommodate different sized hands.

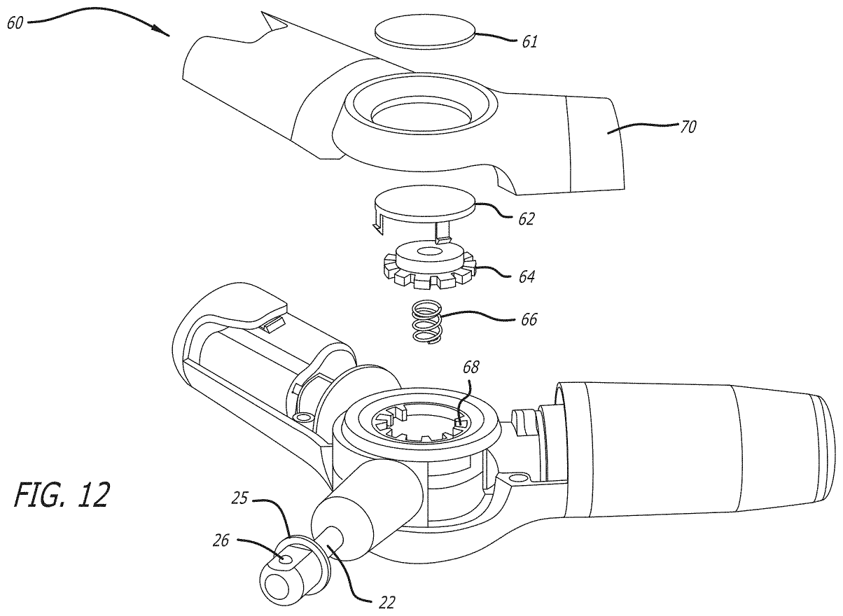

FIG. 12 is partially exploded view of the massager of FIG. 4, showing the rotation locking mechanism 60 in exploded form. Not explicitly shown in the figure is that a number of teeth similar to teeth 68 are formed integral with or affixed to housing cover 70 on the underside thereof. In the nominal state of the massager, toothed sprocket 64 is biased by spring 66 up against sprocket retention cap 62. In that position the teeth of sprocket 64 engage both at least a first tooth 68 on massager body 11 which are rotationally coupled to output shaft 22, and at least a second tooth from among teeth 72 on housing cover 70. In that position sprocket 64 rotationally locks tooth 68 to at least a second tooth 72, and thus rotationally locks output shaft 22 at a specified rotational position relative to housing cover 70 and hence body 11.

When a user presses decorative cap 61 which acts as a lock release push button, sprocket 64 is pressed against spring 66 to thereby compress spring 66. Sprocket 64 moves downward so that it no longer engages teeth 72. In that position sprocket 64 and teeth 68 are free to rotate relative to teeth 72, and hence output shaft 22 is free to rotate relative to body 11. When output shaft 22 is in the position desired by the user, he releases push button 61 thereby locking output shaft 22 into position. Other releasable locking mechanisms are possible.

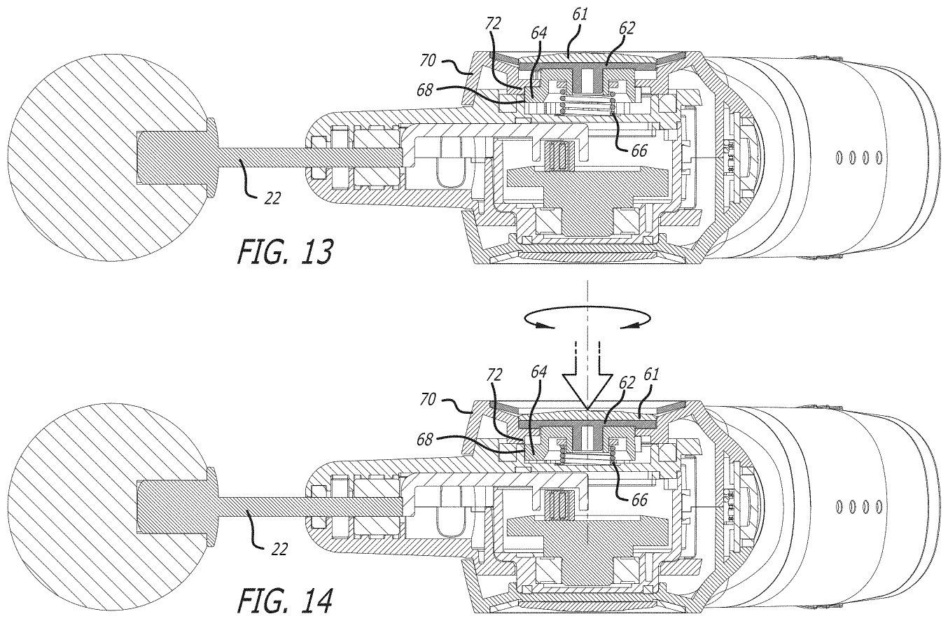

FIG. 13 is a sectional view of the massager of FIG. 12 but non-exploded, showing the rotation locking mechanism in its locked position, i.e., its unpressed position. In this position the teeth of sprocket 24 mesh with both teeth 68 and teeth 72, preventing rotation.

FIG. 14 is a sectional view of the massager of FIG. 12 but non-exploded, showing the rotation locking mechanism in its unlocked position, i.e., when release push button 61 is pressed. In this position sprocket 24 is displaced downward such that it meshes with teeth 68 but not with teeth 72, allowing rotation.

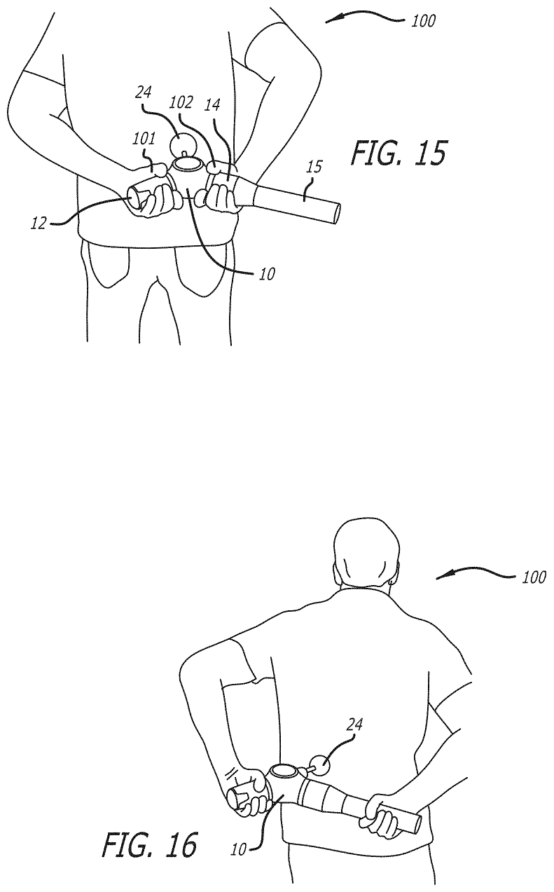

FIGS. 15-20 illustrate a number of uses of the device to apply a percussive massage to various parts of the body. It is believed that the uses shown were not possible or at least not as easily achieved with any prior art percussive massagers.

FIG. 15 is a rear view of a user using the massager of FIG. 1 according to a first possible use thereof. In this use the pivot mechanism is in its nominal position such that the massager 10 has a Y-shaped configuration. The user 100 holds the first handle portion 12 in the user's first hand 101, and the second handle portion 14 in the user's second hand 102. As can be seen in the figure, the handle portions are angled so that the massager is suitable for being comfortably, naturally, and ergonomically held by first and second hands of a user while holding the percussive electric massage appliance behind the user's back, and in particular the user's lower back, while the percussive massage head 24 repeatedly impacts lower back muscles of the user. The user can thus comfortably hold the percussive massage appliance 10 with both hands while delivering to himself a percussive massage via reciprocating action of the percussive massage head. In this position the user can pull the device toward his own back using a pulling motion which allows the user to pull the massager against his back with significant force. This operation is optimum for delivering a percussive massage to an area of the back near or adjacent to the spine.

FIG. 16 is a rear view of a user using the massager of FIG. 1 according to a second possible use. The massager 10 has its output shaft 22 and the massage ball 24 attached thereto pivoted so that the reciprocation axis A3 is in-line with the longitudinal axis A1 of first handle portion 12, similar to the rotational position shown in FIG. 9. In this position the user can pull the massager toward him with significant force using his left hand, while using his right hand and extension handle 15 for stability. It is anticipated that this configuration would be used to provide a massage to a portion of the back that is farther away from the spine than shown in FIG. 15.

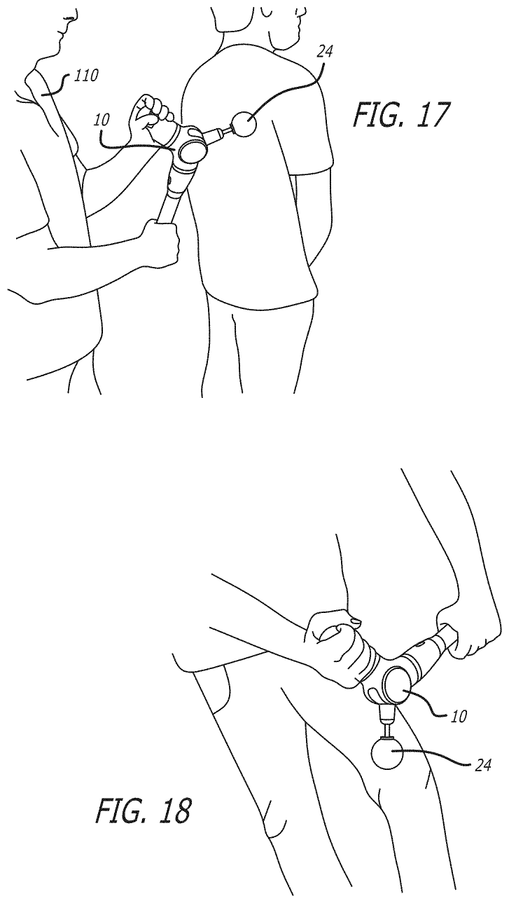

FIG. 17 is a perspective view of a therapist 110 using the massager of FIG. 1 on a patient according to a third possible use. The two handles allows the therapist to apply the massage with significant force, and the relatively large distance between the locations where the therapist is gripping the device allow for significant stability so that the massager 10 does not easily slip away from its intended position and the targeted spot on the patient's body.

FIG. 18 is a perspective view of a user using the massager of FIG. 1 according to a fourth possible use. Again, the two handles allow the massage to be applied with significant force, and the wide handle distance provides stability.

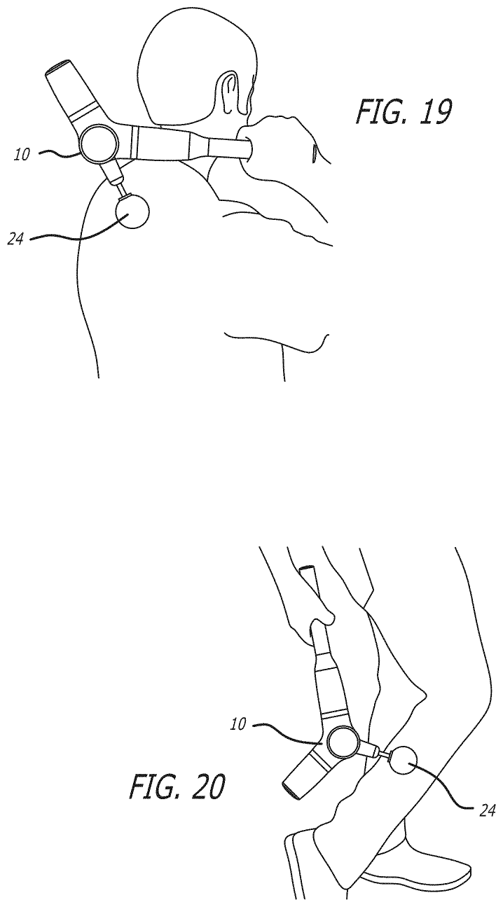

FIG. 19 is a perspective view of a user using the massager of FIG. 1 according to a fifth possible use. The acute angle between output shaft 22 and the extension handle 15 enables a hooking action in which the user uses his right hand on extension handle 15 to pull the massager 24 toward the target location on his back, thus allowing the user to apply the massager with significant force against his own back. In this position the user could also use his left hand to help guide and steady the massager.

FIG. 20 is a perspective view of a user using the massager of FIG. 1 according to a sixth possible use. The extension handle 15 allows the massage head 24 to reach places on the body that otherwise would have required more bending or contortion by the user, including a calf muscle as shown, as well as the soles of the feet.

Although not illustrated, the massager would also allow a seated user to pull the percussive massager 10 against the back of his thigh muscles with significant force, delivering a result that had not been previously achieved or at least not as easily achieved.

The massager of the present invention thus provides a versatile and ergonomic percussive massage to a user, with the user being able to use the device to deliver percussive massage to various target areas on his body more easily and with more stability and force, than with prior art massagers.

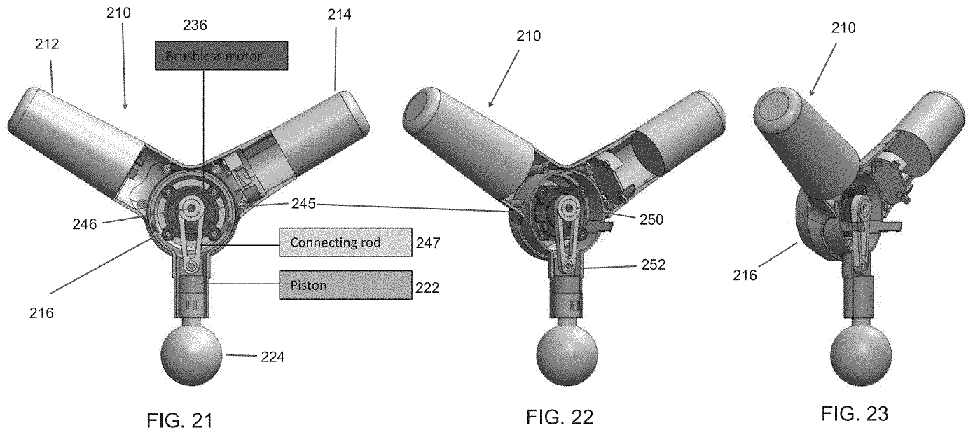

FIGS. 21-23 are side are partially cutaway views of a percussive electric massage appliance 210 according to a second exemplary embodiment, having a centrally located side-mounted motor 236 which is preferably a brushless motor. Motor 236 is located in the central portion 216 of massager 210. In these partial cutaway views the motor 236 and the drive train components are visible. Brushless motors have the advantages of delivering more torque, being smaller, and being maintenance-free and not producing any brush dust. Motor 236 is “side-mounted” meaning that it is mounted to the side of eccentrically mounted crank pin 246 and connecting rod 247 which delivers reciprocating power to piston or massager output shaft 222. The power train can include hub bearings 250 and 252 to allow connecting rod 247 to rotate freely at its upper end about crank pin 246, and at its lower end on a similar pin on the upper end of piston 222.

Crank wheel 245 is affixed to the rotating output shaft, or crank shaft, of motor 236. Crank pin 246 is eccentrically mounted on crank wheel 245 such that as the motor turns the crank shaft and crank wheel 245 rotate, and crank pin 246 traces a circular path. Connecting rod 247 is connected on one end to crank pin 246, and at the other end to piston 222. Connecting rod 247 translates the circular motion of motor 236 to reciprocating motion of piston 226. At the distal end of piston 222 is a massage treatment head 224 such as a resilient ball.

This design eliminates the gearing of the first illustrative embodiment including bevel gears 44 and 45 between the rotating motor shaft and the reciprocating massager output shaft. This second embodiment is therefore quieter and more efficient than the first embodiment. Additionally, brushless motors are generally smaller in size than brushed motors having the same amount of torque, so motor 236 can be side-mounted without extending significantly beyond the main body of massager 210.

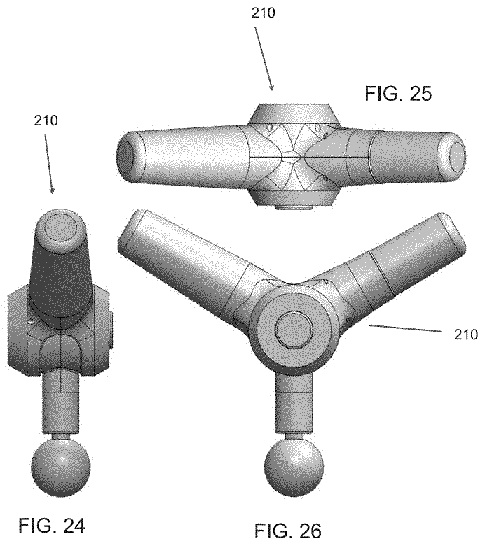

FIGS. 24-26 are side, front, and bottom views, respectively, of the percussive electric massage appliance 210 of FIG. 21.

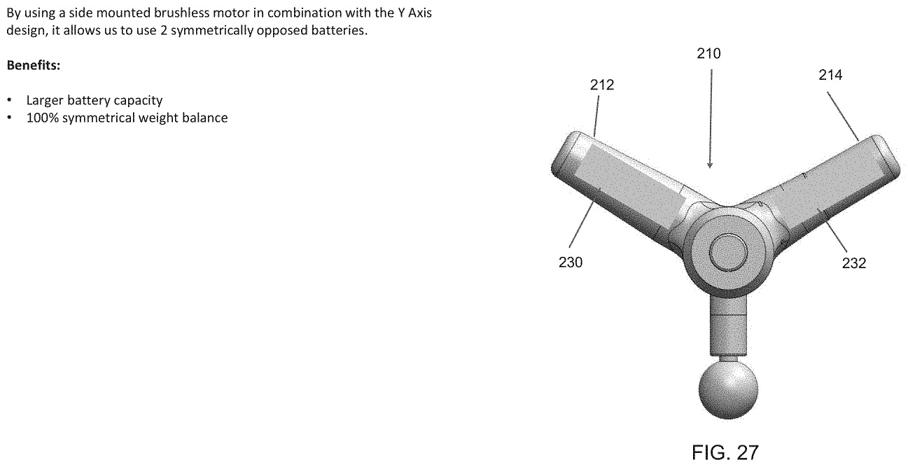

Side-mounting the brushless motor 236 as in this embodiment provides the additional advantage that the space within both handle portions 212 and 214 is now available for mounting batteries therein. FIG. 27 is a conceptual diagram illustrating the spaces available for batteries 230, 232 in the second illustrative embodiment of FIG. 21. This increased space for batteries can mean both larger total battery charge capacity and hence longer operating time on a single charge, as well as 100% symmetric weight balance between left and right handles.

As with the first embodiment, the output shaft 222 can pivot with respect to the handles, and through the same range of angles, and can be locked at various angles. Additionally, an extension handle similar to extension handle 15 could mate and lock with one of the handle portions 212, 214.

It will be understood that the terms “generally,” “approximately,” “about,” “substantially,” “orthogonal,” and “parallel” as used within the specification and the claims herein allow for a certain amount of variation from any exact dimensions, measurements, and arrangements, and that those terms should be understood within the context of the description and operation of the invention as disclosed herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

It will be appreciated that the term “present invention” as used herein should not be construed to mean that only a single invention having a single essential element or group of elements is presented. Similarly, it will also be appreciated that the term “present invention” encompasses a number of separate innovations and features which can each be considered separate inventions. Although the present invention has thus been described in detail with regard to the preferred embodiments and drawings thereof, it should be apparent to those skilled in the art that various adaptations and modifications of the present invention may be accomplished without departing from the spirit and the scope of the invention. For example, the massager could include the standard feature of a variable speed motor and associated variable speed control. Additionally, the massager could be modified to give it a variable reciprocating stroke length. Still further, the massage could operate from battery power and/or wall power such as 120 VAC.

Accordingly, it is to be understood that the detailed description and the accompanying drawings as set forth hereinabove are not intended to limit the breadth of the present invention, which should be inferred only from the following claims and their appropriately construed legal equivalents.

We claim:

1. A percussive electric massage appliance comprising: a body, the body comprising:
a central portion;
a first handle portion extending away from the central portion along a first axis, the first handle portion being suitable for grasping by a first hand of an operator; and
a second handle portion extending away from the central portion along a second axis, the second handle portion being suitable for grasping by a second hand of the operator;
an electric motor drive assembly disposed within the central portion, the electric drive motor assembly including at least an electric drive motor, the electric motor having a drive shaft rotated by the electric motor;
a crank wheel mounted to the drive shaft, the crank wheel having a crank pin eccentrically mounted thereto;
a connecting rod connected to the crank pin at a first end of the connecting rod, and connected to a reciprocating output shaft at a second end of the connecting rod opposite the first end.

2. The percussive electric massage appliance of claim 1 further comprising a massage treatment head attached at a distal end of the reciprocating output shaft.

3. The percussive electric massage appliance of claim 1 wherein the electric motor's drive shaft extends orthogonally to the reciprocating output shaft.

4. The percussive electric massage appliance of claim 1 wherein the electric motor's drive shaft extends orthogonally to the reciprocating output shaft, and to the first and second handle portions.

5. The percussive electric massage appliance of claim 1 further comprising:
a first battery disposed within the first handle portion; and
a second battery disposed with the second handle portion.

6. The percussive electric massage appliance of claim 1 wherein the electric motor is a brushless motor.

7. The percussive electric massage appliance of claim 1 wherein the massager does not having any gears operatively connected between the electric motor drive shaft and the reciprocating output shaft.

8. A percussive electric massage appliance comprising: a body, the body comprising:
a central portion;
a first handle portion extending away from the central portion along a first axis, the first handle portion being suitable for grasping by a first hand of an operator; and
a second handle portion extending away from the central portion along a second axis, the second handle portion being suitable for grasping by a second hand of the operator;
a reciprocating output shaft extending from the central portion;
a brushless electric motor having a drive shaft rotated thereby, the drive shaft extending orthogonally to the reciprocating output shaft and to the first axis;
a crank wheel mounted to the drive shaft, the crank wheel having a crank pin eccentrically mounted thereto;
a connecting rod connected to the crank pin and to the reciprocating output shaft, whereby circular motion of the crank wheel is converted into reciprocating motion of the reciprocating output shaft to deliver a percussive massage to a subject;
the massager not having any gears operatively connected between the electric motor drive shaft and the reciprocating output shaft.
